(19) United States
(12) Patent Application Publication
(10) Pub. No.: US 2026/0361042 A1
(43) Pub. Date: Nov. 12, 2026

(54) Conductive Block, Electrical Connection Module and Power Connector

(71) Applicant: Tyco Electronics (Shanghai) Co., Ltd., Shanghai (CN)

(72) Inventors: YuQiang (Thomas) Zhao, Shanghai (CN); William (Wei) Yao, Kunshan (CN); Qianjin (Orando) Li, Shanghai (CN)

(73) Assignee: Tyco Electronics (Shanghai) Co., Ltd., Shanghai (CN)

(21) Appl. No.: 19/674,407

(22) Filed: May 12, 2026

(30) Foreign Application Priority Data
May 12, 2025 (CN) 202510610886.X

(51) Int. Cl. H01R 25/14

(52) U.S. Cl. CPC H01R 25/142

(57) ABSTRACT

A conductive block includes a plurality of terminal slots. The terminal slots are formed in the conductive block. The conductive block electrically contacts a plurality of terminals respectively inserted into the terminal slots and is fastened to a busbar, such that the terminals are electrically connected to the busbar via the conductive block.

### CROSS-REFERENCE TO RELATED APPLICATION

This application claims the benefit of the filing date under 35 U.S.C. § 119(a)-(d) of Chinese Patent Application No. CN202510610886.X filed on May 12, 2025, the whole disclosure of which is incorporated herein by reference.

### FIELD OF THE INVENTION

The present invention relates to a conductive block and, more particularly, to a conductive block, an electrical connection module comprising the conductive block, and a power connector comprising the electrical connection module.

### BACKGROUND

A terminal of a power connector is usually directly connected to a circuit board and electrically connected to a busbar via the circuit board. When the current flowing through the terminal is large, it is necessary to increase the cross-sectional size of the conductive tracks on the circuit board to be able to carry the large current. However, this will lead to an increase in the size and cost of the circuit board. In addition, the circuit board also has disadvantages such as poor current carrying capacity, long conductive paths, and high power consumption.

### SUMMARY OF THE INVENTION

A conductive block includes a plurality of terminal slots. The terminal slots are formed in the conductive block. The conductive block electrically contacts a plurality of terminals respectively inserted into the terminal slots and is fastened to a busbar, such that the terminals are electrically connected to the busbar via the conductive block.

### BRIEF DESCRIPTION OF DRAWINGS

The invention will now be described by way of example with reference to the accompanying figures, of which:

FIG. 1 is a perspective view of a power connector according to an exemplary embodiment;

FIG. 2 is an exploded view of the power connector of FIG. 1;

FIG. 3 is an exploded view of an electrical connection module of the power connector of FIG. 1;

FIG. 4 is an exploded sectional view of the electrical connection module of FIG. 3;

FIG. 5 is another exploded view of the electrical connection module of FIG. 3;

FIG. 6 is an exploded view of terminals of the power connector of FIG. 1;

FIG. 7 is a perspective view of a bottom of the electrical connection module of FIG. 3; and

FIG. 8 is a perspective view of a power connector according to another exemplary embodiment.

### DETAILED DESCRIPTION

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

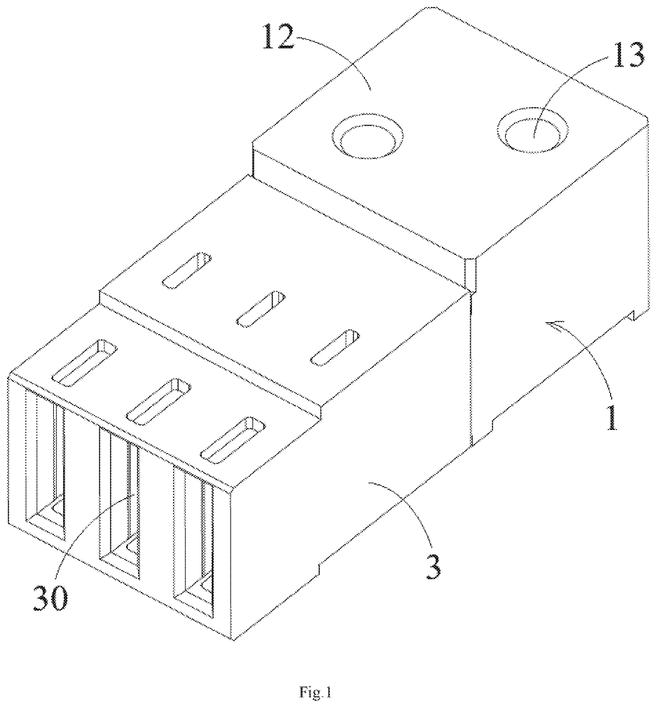

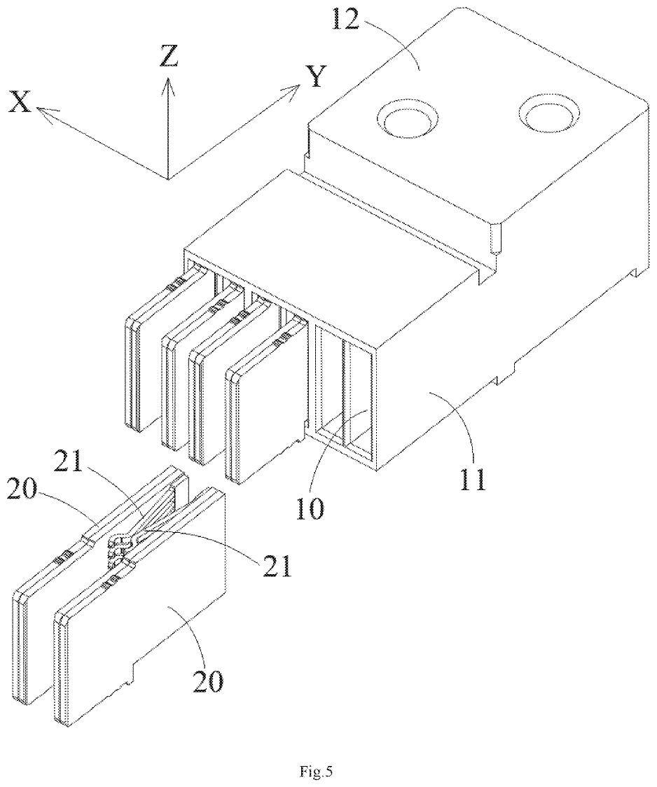

An exemplary embodiment of a conductive block 1 will now be described with reference to FIGS. 1-7. As shown in FIGS. 1-3, multiple terminal slots 10 are formed in the conductive block 1. The conductive block 1 is adapted to make electrical contact with multiple terminals 2 respectively inserted into multiple terminal slots 10 and to be fastened to a busbar, so that multiple terminals 2 can be electrically connected to the busbar via the conductive block 1. The conductive block 1 can be an integral copper block or an integral copper alloy block.

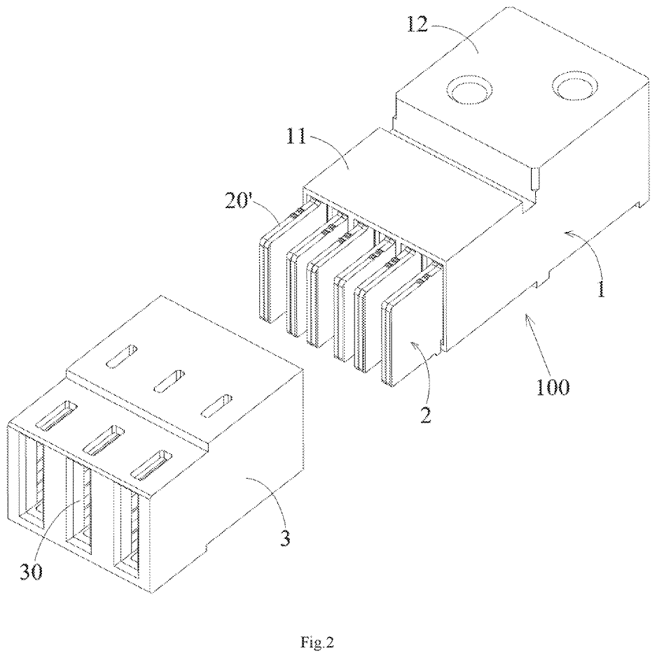

As shown in FIGS. 2-5, the conductive block 1 has a front block body 11 and a rear block body 12 that are opposite in its longitudinal direction Y. The multiple terminal slots 10 are formed in the front block body 11, and the rear block body 12 is used for fastening to the busbar.

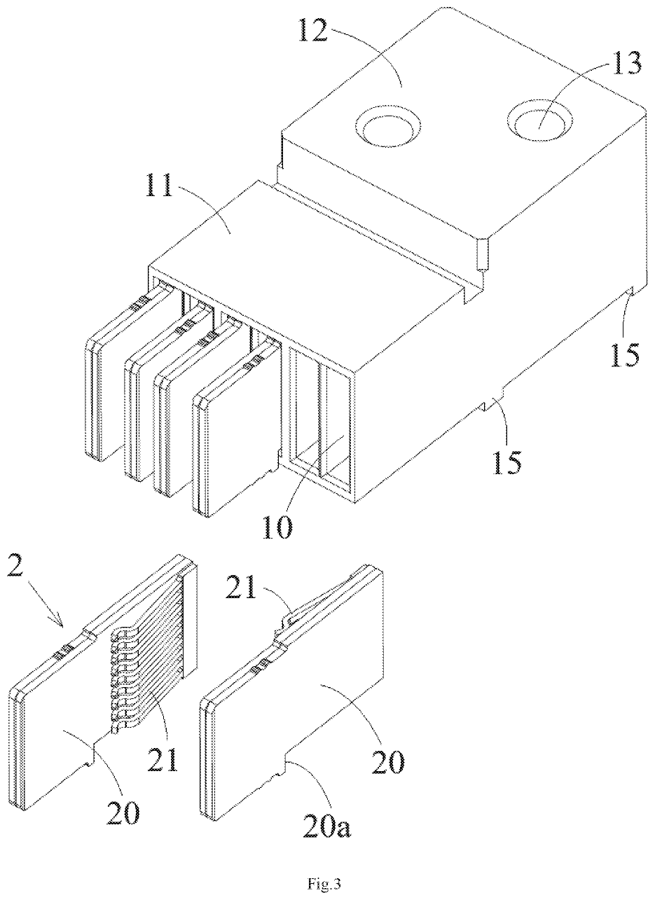

As shown in FIGS. 3-5, the multiple terminal slots 10 are arranged in a row in the transverse direction X of the conductive block 1 and extend along the longitudinal direction Y and height direction Z of the conductive block 1.

As shown in FIGS. 1, 3-4, and 7, a threaded hole 13 extending along the height direction Z of the conductive block 1 is formed in the rear block body 12. The threaded hole 13 is used to connect with a threaded connection member (such as a bolt), so that the conductive block 1 can be fastened to the busbar via the threaded connection member connected to the threaded hole 13.

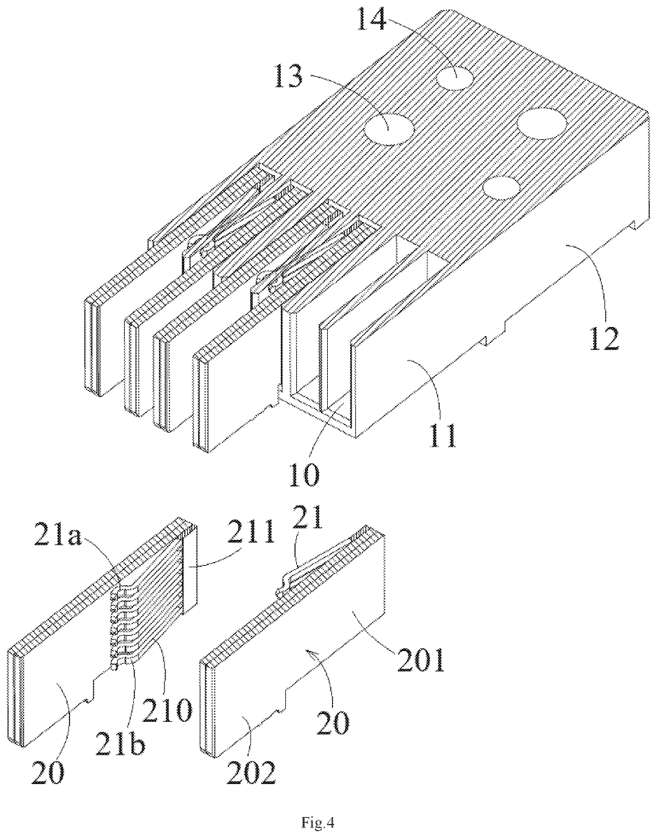

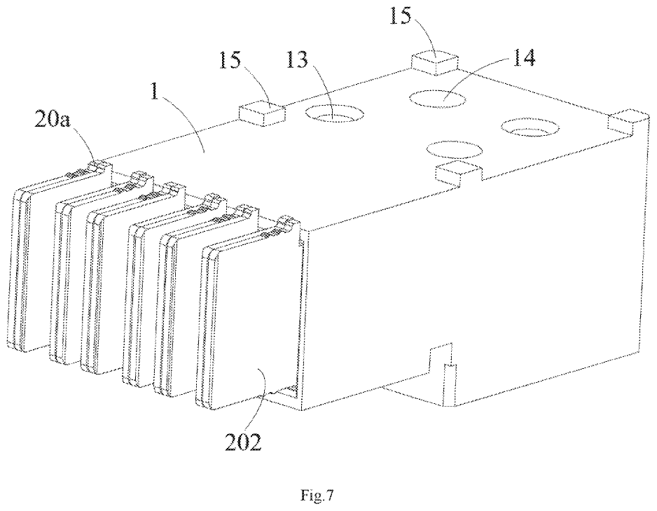

As shown in FIGS. 4 and 7, a positioning hole 14 extending along the height direction Z of the conductive block 1 is formed in the bottom surface of the rear block body 12. The positioning hole 14 is suitable for cooperating with a positioning post on a circuit board to position the conductive block 1 on the circuit board.

As shown in FIGS. 3 and 7, multiple support legs 15 are formed on the bottom surface of the conductive block 1. The multiple support legs 15 are suitable for supporting on the top surface of the circuit board.

An exemplary embodiment of an electrical connection module 100 will now be described with reference to FIGS. 1-7. As shown in FIG. 2, the electrical connection module 100 includes the aforementioned conductive block 1 and the multiple terminals 2. The multiple terminals 2 are respectively inserted into the multiple terminal slots 10 of the conductive block 1. The multiple terminals 2 are in electrical contact with the conductive block 1, and the conductive block 1 is suitable for being fastened to a busbar, so that the multiple terminals 2 can be electrically connected to the busbar via the conductive block 1.

As shown in FIGS. 3-5, the terminal 2 includes a terminal board 20 and an elastic component 21. The terminal board 20 has an insertion portion 201, as shown in FIG. 4, that is inserted into the terminal slot 10 of the conductive block 1. The elastic component 21 is fixed to the surface of the insertion portion 201 of the terminal board 20. The elastic component 21 is inserted into the terminal slot 10 and makes electrical contact with the inner wall surface of the terminal slot 10.

As shown in FIGS. 3-5, the terminal slot 10 has two inner wall surfaces opposite each other in the transverse direction X of the conductive block 1. The terminal board 20 is attached to one inner wall surface of the terminal slot 10, and the elastic component 21 is in electrical contact with the other inner wall surface of the terminal slot 10.

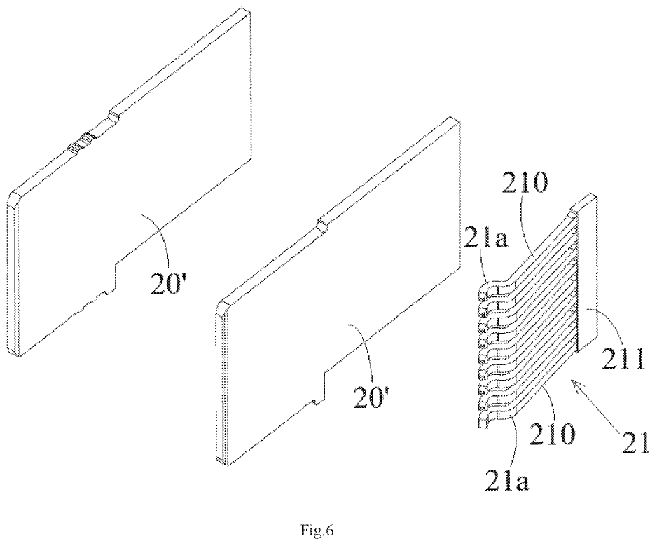

As shown in FIGS. 4 and 6, the elastic component 21 includes a strip-shaped portion 211 and a row of elastic arms 210. The strip-shaped portion 211 is fixed to the terminal board 20. The row of elastic arms 210 are connected to the strip-shaped portion 211. The strip-shaped portion 211 extends along the height direction Z of the conductive block 1, and the row of elastic arms 210 are in electrical contact with the inner wall surface of the terminal slot 10 of the conductive block 1. The strip-shaped portion 211 of the elastic component 21 can be welded, crimped, or riveted to the terminal board 20.

As shown in FIG. 4, the end portion 21a of the elastic arm 210 is supported on the terminal board 20 in a movable manner. The elastic arm 210 has a contact protrusion 21b near its end portion 21a. The contact protrusion 21b is in electrical contact with the inner wall surface of the terminal slot 10 of the conductive block 1.

As shown in FIGS. 3-5, the multiple terminals 2 are arranged in pairs, and the elastic components 21 of each pair of terminals 2 face each other, so that the partition wall between adjacent terminal slots 10 is clamped between the elastic components 21 of adjacent terminals 2.

As shown in FIGS. 4 and 7, the terminal board 20 also has a connection part 202 located outside the terminal slot 10 of the conductive block 1. The connection part 202 of the terminal board 20 is used for electrical connection with a mating terminal or a power transmission component (such as a busbar or a cable).

As shown in FIG. 3, a positioning step 20a is formed at the bottom of the connection part 202 of the terminal board 20, which, as shown in FIG. 7, is pressed against the lower side edge of the entrance of the terminal slot 10 of the conductive block 1 to position the terminal board 20 in the longitudinal direction Y of the conductive block 1.

As shown in FIG. 6, the terminal board 20 may include multiple layers of conductive plates 20′ stacked together, which can be welded, riveted, or crimped together.

An exemplary embodiment of a power connector will now be described with reference to FIGS. 1-7. As shown in FIG. 2, the power connector includes an insulation housing 3 and the aforementioned electrical connection module 100. The multiple terminals 2 of the electrical connection module 100 and the front block body 11 of the conductive block 1 are arranged in the insulation housing 3, and the rear block body 12 of the conductive block 1 is located outside the insulation housing 3 for electrical connection to a busbar.

As shown in FIGS. 1-2, an insertion slot 30 is formed in the insulation housing 3 to allow for the insertion of the mating terminal or the power transmission component. The connection part 202 of the terminal 2 is used to electrically connect with the mating terminal or the power transmission component inserted into the insertion slot 30.

The insulation housing 3 is suitable for being fixed to the circuit board, and the rear block body 12 of the conductive block 1 is suitable for being supported and positioned on the circuit board. When the power connector is installed on the circuit board, the multiple terminals 2 and the conductive block 1 of the electrical connection module 100 are not electrically connected to the circuit board.

In the aforementioned exemplary embodiments according to the present invention, the multiple terminals 2 of the power connector are electrically connected to the conductive block 1 and connected to the busbar via the conductive block 1. In the present invention, since the terminal current does not flow through the circuit board, the size and cost of the circuit board can be reduced, and the current path can be shortened and power consumption can be reduced. In addition, in the aforementioned exemplary embodiments of the present invention, the multiple terminals 2 of the power connector are electrically connected to the same conductive block 1, without the need to be separately electrically connected to multiple conductive components, thus reducing the number of components and achieving a certain degree of flexibility. Additionally, the elastic component 21 of the terminal 2 can undergo elastic deformation, which allows the conductive block 1 to float relative to the terminal 2.

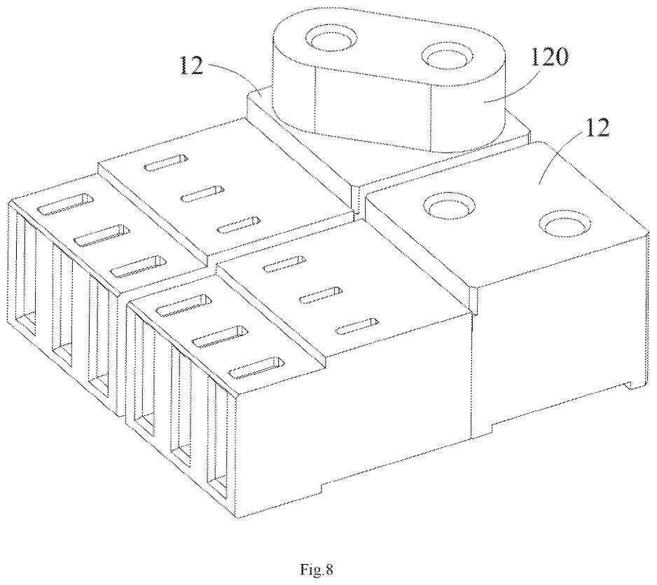

Another exemplary embodiment of a power connector will now be described with reference to FIG. 8.

As shown in FIG. 8, the power connector comprises two electrical connection modules 100 arranged side by side in the transverse direction X. The two electrical connection modules 100 are used to electrically connect to a positive busbar and a negative busbar, respectively. The positive and negative busbars are suitable for being respectively fastened to the top of the rear block bodies 12 of the conductive blocks 1 of the two electrical connection modules 100, and the rear block bodies 12 of the conductive blocks 1 of the two electrical connection modules 100 have a predetermined height difference in the height direction Z to ensure that the positive and negative busbars connected to the two electrical connection modules 100 are at different heights. In the illustrated embodiment, a top protrusion 120 is formed on the rear block body 12 of the conductive block 1 of one electrical connection module 100, such that the top surface of the rear block body 12 of the conductive block 1 of the one electrical connection module 100 is higher than the top surface of the rear block body 12 of the conductive block 1 of the other electrical connection module 100.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. A conductive block, comprising:
a plurality of terminal slots, the terminal slots are formed in the conductive block, the conductive block electrically contacts a plurality of terminals respectively inserted into the terminal slots and is fastened to a busbar, such that the terminals are electrically connected to the busbar via the conductive block.

2. The conductive block of claim 1, wherein the conductive block is an integral copper block or an integral copper alloy block.

3. The conductive block of claim 1, wherein the conductive block has a front block body and a rear block body that are opposite in a longitudinal direction of the conductive block, the terminal slots are formed in the front block body, the rear block body is fastened to the busbar.

4. The conductive block of claim 3, wherein the terminal slots are arranged in a row in a transverse direction of the conductive block and extend along the longitudinal direction and a height direction of the conductive block.

5. The conductive block of claim 3, wherein a threaded hole extending along a height direction is formed in the rear block body, the threaded hole connects with a threaded connection member, the conductive block is fastened to the busbar via the threaded connection member connected to the threaded hole.

6. The conductive block of claim 5, wherein a positioning hole extending along the height direction is formed in a bottom surface of the rear block body, the positioning hole cooperates with a positioning post on a circuit board to position the conductive block on the circuit board.

7. The conductive block of claim 6, wherein a plurality of support legs are formed on the bottom surface of the conductive block, the support legs support the conductive block on a top surface of the circuit board.

8. An electrical connection module, comprising:
a conductive block including a plurality of terminal slots formed in the conductive block; and
a plurality of terminals respectively inserted into the terminal slots, the terminals electrically contact the conductive block, and the conductive block is fastened to a busbar, such that the terminals are electrically connected to the busbar via the conductive block.

9. The electrical connection module of claim 8, wherein each terminal has a terminal board and an elastic component, each terminal board has an insertion portion inserted into one terminal slot, each elastic component is fixed to a surface of the insertion portion of one terminal board, each elastic component is inserted into the respective terminal slot and electrically contacts an inner wall surface of the respective terminal slot.

10. The electrical connection module of claim 9, wherein each terminal slot has two opposite inner wall surfaces in a transverse direction, the terminal board of one terminal is attached to one inner wall surface of one terminal slot and the elastic component of the one terminal is in electrical contact with an other inner wall surface of the one terminal slot.

11. The electrical connection module of claim 9, wherein each elastic component has a strip-shaped portion and a row of elastic arms connected to the strip-shaped portion, the strip-shaped portion of the elastic component of one terminal is fixed to the terminal board of the one terminal, each strip-shaped portion extends along a height direction, the row of elastic arms of the elastic component of the one terminal are in electrical contact with the inner wall surface of the respective terminal slot.

12. The electrical connection module of claim 11, wherein the strip-shaped portion of the elastic component of each terminal is welded, crimped, or riveted to the terminal board of the respective terminal.

13. The electrical connection module of claim 11, wherein an end portion of each elastic arm in each row of elastic arms is supported on the respective terminal board in a movable manner, each elastic arm has a contact protrusion adjacent its end portion, each contact protrusion is in electrical contact with the inner wall surface of the respective terminal slot.

14. The electrical connection module of claim 9, wherein the terminals are arranged in pairs, the elastic components of each pair of terminals face each other such that a partition wall between adjacent terminal slots is clamped between the elastic components of each pair of terminals.

15. The electrical connection module of claim 9, wherein each terminal board has a connection part located outside the respective terminal slot when each terminal is inserted into the respective terminal slot, the connection part of each terminal board electrically connects with a mating terminal or a power transmission component.

16. The electrical connection module of claim 15, wherein a positioning step is formed at the bottom of the connection part of each terminal board, each positioning step is pressed against a lower side edge of an entrance of the respective terminal slot to position each terminal board in a longitudinal direction of the conductive block.

17. The electrical connection module of claim 9, wherein each terminal board has a plurality of layers of conductive plates stacked together, which are welded, riveted, or crimped together.

18. A power connector, comprising:
an insulation housing; and
an electrical connection module including a conductive block and a plurality of terminals, the conductive block includes a plurality of terminal slots formed in the conductive block, the terminals are respectively inserted into the terminal slots, the terminals electrically contact the conductive block, and the conductive block is fastened to a busbar, such that the terminals are electrically connected to the busbar via the conductive block, the terminals and a front block body of the conductive block are arranged in the insulation housing, a rear block body of the conductive block is located outside the insulation housing for electrical connection to the busbar.

19. The power connector of claim 18, wherein an insertion slot is formed in the insulation housing, a connection part of each terminal electrically connects with a mating terminal or a power transmission component inserted into the insertion slot.

20. The power connector of claim 18, wherein the insulation housing is fixed to a circuit board, the rear block body of the conductive block is supported and positioned on the circuit board, when the power connector is installed on the circuit board, the terminals and the conductive block are not electrically connected to the circuit board.

21. The power connector of claim 18, wherein the power connector includes two electrical connection modules arranged side by side in a transverse direction, each electrical connection module electrically connects to one of a positive busbar and a negative busbar, the positive busbar and the negative busbar are respectively fastened to a top of each rear block body, each rear block body has a different height in a height direction.
